(19) United States
(12) Patent Application Publication
(10) Pub. No.: US 2023/0389720 A1
(43) Pub. Date: Dec. 7, 2023

(54) Drink Lid Dispenser Assembly

(71) Applicant: Angela Johnson, Zanesville, OH (US)

(72) Inventor: Angela Johnson, Zanesville, OH (US)

(21) Appl. No.: 17/831,616

(22) Filed: Jun. 3, 2022

(51) Int. Cl. A47F 1/08; B65G 59/06; A47G 19/30

(52) U.S. Cl. CPC A47F 1/085; B65G 59/066; A47G 21/184; B65G 2814/0308; B65G 2203/044

(57) ABSTRACT

A drink lid dispenser assembly includes a lid housing which contains a stack of drink container lids. A lid dispenser unit is movably integrated into the lid housing. The lid dispenser unit includes a lid screw which engages a bottommost lid in the stack of drink container lids thereby facilitating the bottommost lid to fall outwardly from the lid housing to deliver the bottommost lid to a user. A straw dispenser is coupled to the lid housing and the straw dispenser contains a stack of drinking straws. The straw dispenser includes a screw engaging a bottommost straw in the stack of drinking straws. The screw in the straw dispenser urges the bottommost straw outwardly from the straw dispenser when the straw dispenser is turned on to deliver the bottommost straw to the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dispenser device and more particularly pertains to a new dispenser device for dispensing drink container lids in a touchless manner. The device includes a lid housing and a lid dispenser unit attached to the lid housing, which is motion activated, to dispense a drink container lid when a user places their hand beneath the lid housing. The device includes a straw dispenser that is attached to the lid housing, which is motion activated, to dispense a drinking straw when the user places their hand beneath the straw dispenser. The device additionally includes a hand sanitizer dispenser, which is motion activated, to dispense hand sanitizer when the user places their hand beneath the hand sanitizer dispenser.

### (2) Description of Related Art Including Information Disclosed Under 37 CFR 1.97 and 1.98.

The prior art relates to dispenser devices including a manually operated lid dispenser that includes a lever and an extractor which removes a lid from a stack of lids when the lever is manipulated. The prior art discloses a lid dispensing device that includes a piston and a press plate for urging a lid onto a drink container. The prior art discloses a stackable object dispenser that includes a box with an opening and a retention member extending upwardly from the opening for holding a stock of objects to be dispensed through the opening. The prior art discloses a lid dispenser which includes a motion activated dispenser for dispensing a lid when a user approaches the lid dispenser. The prior art discloses a utensil dispenser that includes a housing and a skewer in the housing around which a stack of utensils is positioned.

### BRIEF SUMMARY OF THE INVENTION

An embodiment of the disclosure meets the needs presented above by generally comprising a lid housing which contains a stack of drink container lids. A lid dispenser unit is movably integrated into the lid housing. The lid dispenser unit includes a lid screw which engages a bottommost lid in the stack of drink container lids thereby facilitating the bottommost lid to fall outwardly from the lid housing to deliver the bottommost lid to a user. A straw dispenser is coupled to the lid housing and the straw dispenser contains a stack of drinking straws. The straw dispenser includes a screw engaging a bottommost straw in the stack of drinking straws. The screw in the straw dispenser urges the bottommost straw outwardly from the straw dispenser when the straw dispenser is turned on to deliver the bottommost straw to the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a drink lid dispenser assembly according to an embodiment of the disclosure.

FIG. 2 is a cross sectional view taken along line 2-2 of FIG. 1 of an embodiment of the disclosure.

FIG. 3 is a schematic view of an embodiment of the disclosure.

FIG. 4 is a front view of an embodiment of the disclosure.

FIG. 5 is a cut-away in-use view of an embodiment of the disclosure.

FIG. 6 is a perspective in-use view of an embodiment of the disclosure.

FIG. 7 is a detail view taken from circle 7 of FIG. 5 of an embodiment of the disclosure.

### DETAILED DESCRIPTION OF THE INVENTION

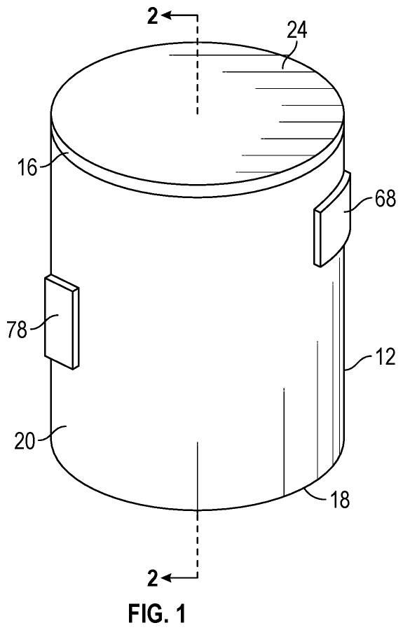

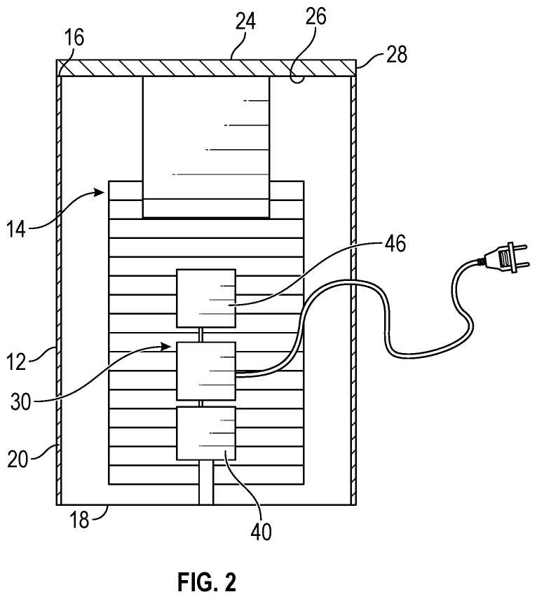

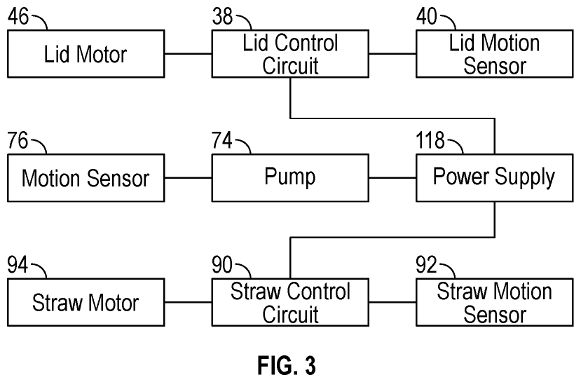

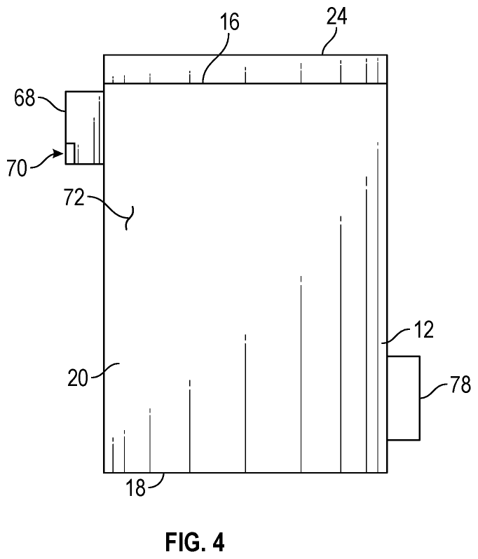

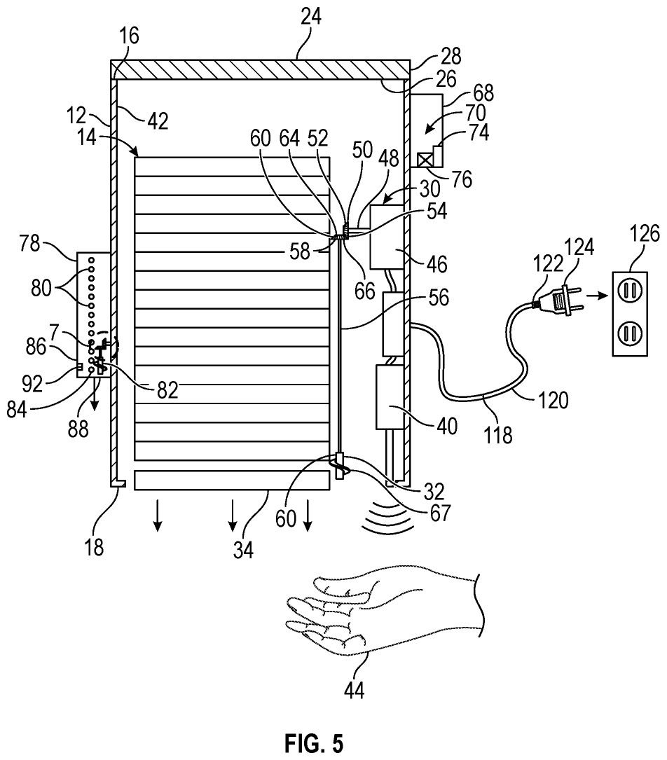

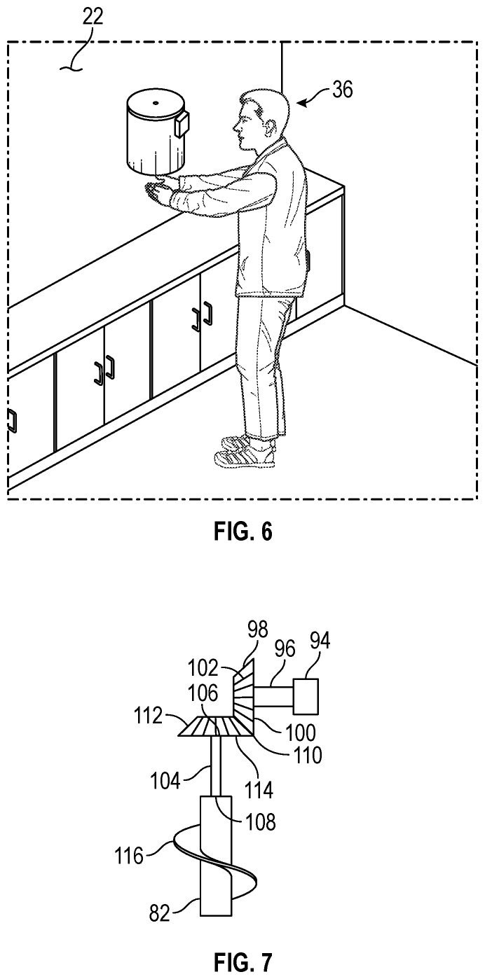

With reference now to the drawings, and in particular to FIGS. 1 through 7 thereof, a new dispenser device embodying the principles and concepts of an embodiment of the disclosure and generally designated by the reference numeral 10 will be described.

As best illustrated in FIGS. 1 through 7, the drink lid dispenser assembly 10 generally comprises a lid housing 12 which contains a stack of drink container lids 14. The drink container lids 14 may be plastic lids for disposable cups that might commonly be found in a convenience store, for example, or other retail location that sells fountain drinks. The lid housing 12 has a top end 16, a bottom end 18 and an outer wall 20 extending between the top end 16 and the bottom end 18. Each of the top end 16 and the bottom end 18 is open to access an interior of the lid housing 12, and the stack of drink container lids 14 is oriented to extend between the top end 16 and the bottom end 18. The outer wall 20 is mounted to a vertical support surface 22, such as a wall or the like, such that top end 16 and the bottom end 18 are aligned with a common vertical axis.

A cover 24 is provided and the cover 24 is removably positioned on the lid housing 12 for closing the lid housing 12. The cover 24 has a bottom side 26 and a perimeter surface 28, and the bottom side 24 rests on the top end 16 of the lid housing 12 having the perimeter surface 28 being aligned with the outer wall 20 of the lid housing 12 thereby closing the top end 16. A lid dispenser unit 30 is movably integrated into the lid housing 12 and the lid dispenser unit 30 includes a lid screw 32 that engages a bottommost lid 34 in the stack of drink container lids 14. The lid screw 32 separates the bottommost lid 34 when the lid dispenser 30 is turned on thereby facilitating the bottommost lid 34 to fall outwardly from the lid housing 12. In this way the lid dispenser unit 30 delivers the bottommost lid 34 to a user 36 without requiring the user 36 to touch the stack of drink container lids 14 thereby reducing the likelihood of physical transmission of bacteria with respect to the drink container lids 14.

The lid dispenser unit 30 comprises a lid control circuit 38 that is integrated into the lid housing 12 and the lid control circuit 38 receives a dispense input. A lid motion sensor 40 is coupled to an inside surface 42 of the outer wall 20 of the lid housing 12 and the lid motion sensor 40 is positioned adjacent to the bottom end 18 of the lid housing 12. The lid motion sensor 40 senses motion such that the lid motion sensor 40 senses when the user's hand 44 is positioned beneath the lid housing 12. The lid motion sensor 40 is electrically coupled to the lid control circuit 38 and the lid control circuit 38 receives the dispense input when the lid motion sensor 40 senses motion. The lid motion sensor 40 may comprise an infrared motion sensor or other type of electronic motion sensor.

The lid dispenser unit 30 includes a lid motor 46 that is coupled to the inside surface 42 of the outer wall 20 of the lid housing 12 and the lid motor 46 is electrically coupled to the lid control circuit 38. The lid motor 46 rotates a predetermined number of revolutions in a first direction when the lid motor 46 is turned on and the lid motor 46 is turned on when the lid control circuit 38 receives the dispense input. The lid motor 46 has an output shaft 48 extending laterally away from the lid motor 46 and the lid motor 46 is positioned closer to the top end 16 of the lid housing 12 than the bottom end 18 of the lid housing 12. Furthermore, the lid motor 46 may comprise an electric motor or the like.

The lid dispenser unit 30 includes a first gear 50 that has an engaging face 52 and a coupling face 54, and the coupling face 54 is attached to the output shaft 48 such that the lid motor 46 rotates the first gear 50 when the lid motor 46 is turned on. Additionally, the engaging face 52 angles inwardly toward a centerline of the first gear 50. The lid dispenser unit 30 includes a lid drive shaft 56 that has an upper end 58 and a lower end and the lid drive shaft 56 is positioned within the lid housing 12. The lid drive shaft 56 is positioned between the outer wall 20 of the lid housing 12 and the stack of drink container lids 14. The lid dispenser 30 includes a second gear 62 that has an engaging face 64 and a coupling face 66, and the coupling face 66 of the second gear 62 is coupled to the upper end 58 of the lid drive shaft 56. The engaging face 64 of the second gear 62 angles inwardly toward a centerline of the second gear 62. Furthermore, the engaging face 64 of the second gear 62 engages the engaging face 52 of the first gear 50 such that each of the first gear 50 and the second gear 62 transfer rotational torque at a perpendicular angle, and the lid drive shaft 56 is rotated when the output shaft 48 rotates.

The lid screw 32 is coupled to the lower end 60 of the lid drive shaft 56 such that the lid screw 32 rotates about an axis extending between the upper end 58 and the lower end 60 of the lid drive shaft 56 when the lid drive shaft 56 is rotated. A thread 67 of the lid screw 32 engages the bottommost lid 34 on the stack of drink container lids 14 and the thread 67 urges the bottommost lid 34 downwardly when the lid screw 32 rotates. The lid screw 32 is rotated one full rotation when the lid motor 46 is turned on thereby facilitating the lid screw 32 to fully dislodge the bottommost lid 34 from the stack of drink container lids 14.

A hand sanitizer dispenser 68 is attached to the lid housing 12 and the hand sanitizer dispenser 68 contains a liquid hand sanitizer 69. The hand sanitizer dispenser 68 has a dispensing element 70 for releasing a pre-determined volume of the liquid hand sanitizer 69 when the user 36 positions their hand beneath the hand sanitizer dispenser 68.

The hand sanitizer dispenser 68 is positioned on an outside surface 72 of the outer wall of the lid housing 12 and the hand sanitizer dispenser 68 is positioned adjacent to the top end 16 of the outer wall 20 of the lid housing 12. Furthermore, the hand sanitizer dispenser 68 has a pump 74 and a motion sensor 76 which together comprise the dispensing element 70 of the hand sanitizer dispenser 68. The pump 74 is directed downwardly on the hand sanitizer dispenser 6, the motion sensor 76 is electrically coupled to the pump 74 and the pump 74 is turned on when the motion sensor 76 senses motion. Furthermore, the pump 74 urges the pre-determined volume of the liquid hand sanitizer 69 outwardly from the hand sanitizer dispenser 68 when the pump 74 is turned on. The pump 74 may comprise an electric fluid pump or the like and the motion sensor 76 in the hand sanitizer dispenser 68 may comprise an infrared motion sensor or other type of electronic motion sensor.

A straw dispenser 78 is coupled to the lid housing 12 and the straw dispenser 78 contains a stack of drinking straws 80. The straw dispenser 78 includes a straw screw 82 which engages a bottommost straw 84 in the stack of drinking straws 80. The straw screw 82 urges the bottommost straw 84 outwardly from the straw dispenser 78 when the straw dispenser 78 is turned on. In this way the bottommost straw 84 can fall downwardly out of the straw dispenser 78 to deliver the bottommost straw 84 to the user 36.

The straw dispenser 78 comprises a straw housing 86 that is attached to the outer surface of the outer wall 20 of the lid housing 12 and the straw housing 86 has a lower end 88 that is open. A straw control circuit 90 is integrated into the lid housing 12 and the straw control circuit 90 receives a dispense input. A straw motion sensor 92 is coupled to an inside surface 93 of the outer wall 20 of the lid housing 12 and the straw motion sensor 92 is positioned adjacent to the bottom end 18 of the lid housing 12. The straw motion sensor 92 senses motion such that the straw motion sensor 92 senses when the user's hand 44 is positioned beneath the lid housing 12. The straw motion sensor 92 is electrically coupled to the straw control circuit 90 and the straw control circuit 90 receives the dispense input when the straw motion sensor 92 senses motion.

The straw dispenser 78 includes a straw motor 94 that is coupled to the inside surface 42 of the outer wall 20 of the lid housing 12 and the straw motor 94 is electrically coupled to the straw control circuit 90. The straw motor 94 rotates a predetermined number of revolutions in a first direction when the straw motor 94 is turned on and the straw motor 94 is turned on when the straw control circuit 90 receives the dispense input. The straw motor 94 has an output shaft 96 which extends laterally away from the straw motor 94 and the straw motor 94 is positioned closer to the top end 16 of the lid housing 12 than the bottom end 18 of the lid housing 12.

The straw dispenser 78 includes a primary gear 98 that has an engaging face 100 and a coupling face 102, and the coupling face 102 of the primary gear 98 is attached to the output shaft 96 of the straw motor 94 such that the straw motor 94 rotates the primary gear 98 when the straw motor 94 is turned on. The engaging face 100 of the primary gear 98 angles inwardly toward a centerline of the primary gear 98. The straw dispenser 78 includes a straw drive shaft 104 that has an upper end 106 and a lower end 108, and the straw drive shaft 104 is positioned within the straw housing 86. The straw drive shaft 104 is positioned between the outer wall 20 of the lid housing 12 and the stack of drinking straws 80.

The straw dispenser 78 includes a secondary gear 110 that has an engaging face 112 and a coupling face 114, and the coupling face 114 of the secondary gear 110 is coupled to the upper end 106 of the straw drive shaft 104. The engaging face 112 of the secondary gear 110 angles inwardly toward a centerline of the secondary gear 110. The engaging face 112 of the secondary gear 110 engages the engaging face 100 of the primary gear 98 such that each of the primary gear 98 and the secondary gear 110 transfer rotational torque at a perpendicular angle. Furthermore, the straw drive shaft 104 is rotated when the output shaft 96 of the straw motor 94 rotates.

The straw screw 82 is coupled to the lower end 108 of the straw drive shaft 104 such that the straw screw 82 rotates about an axis extending between the upper end 58 and the lower end 60 of the straw drive shaft 104 when the straw drive shaft 104 is rotated. A thread 116 of the straw screw 82 engages the bottommost straw 84 on the 25 stack of drinking straws 80 and the thread 116 on the straw screw 82 urges the bottommost straw 84 downwardly when the straw screw 82 rotates. The straw screw 82 is rotated one full rotation when the straw motor 94 is turned on thereby facilitating the straw screw 82 to fully dislodge the bottommost straw 84 from the stack of drinking straws 80.

A power supply 118 is provided and the power supply 118 is coupled to the lid housing 12. Additionally, the power supply 118 is electrically coupled to the lid control circuit 38 and the straw control circuit 90 and the pump 74 in the hand sanitizer dispenser 68. The power supply 118 includes a power cord 120 which extends away from the outer wall 20 of the lid housing 12 and the power cord 120 has a distal end 122 with respect to the outer wall 20. Additionally, a male plug 124 is electrically coupled to the distal end 122 and the male plug 124 engages a power source 126 comprising a female electrical outlet.

In use, the user 36 positions their hand 44 beneath the lid housing 12 thereby triggering the lid dispenser unit 30 dispense a drink container lid 14. In this way the user 36 can retrieve a drink container lid 14 without having to touch the stack of drink container lids 14. The user 36 positions their hand 44 beneath the straw dispenser 78 thereby triggering the straw dispenser 78 to dispense a drinking straw 80. In this way the user 36 can retrieve a drinking straw 80 without having to touch the stack of drinking straws 80. Furthermore, the user 36 can position their hand 44 beneath the hand sanitizer dispenser 68 thereby triggering the hand sanitizer dispenser 68 to dispense liquid hand sanitizer 69 for sanitizing the user's hands 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drink lid dispenser assembly for dispensing a lid for a drink container in a touchless manner thereby inhibiting contact transmission of bacteria, said assembly comprising:
a lid housing containing a stack of drink container lids;
a cover being removably positioned on said lid housing for closing said lid housing;
a lid dispenser unit being movably integrated into said lid housing, said lid dispenser unit including a lid screw engaging a bottommost lid in said stack of drink container lids, said lid screw separating said bottommost lid when said lid dispenser is turned on thereby facilitating said bottommost lid to fall outwardly from said lid housing wherein said lid dispenser unit is configured to deliver said bottommost lid to a user;
a hand sanitizer dispenser being attached to said lid housing, said hand sanitizer dispenser containing a liquid hand sanitizer, said hand sanitizer dispenser having a dispensing element for releasing a pre-determined volume of said liquid hand sanitizer when the user positions their hand beneath said hand sanitizer dispenser; and
a straw dispenser being coupled to said lid housing, said straw dispenser containing a stack of drinking straws, said straw dispenser including a screw engaging a bottommost straw in said stack of drinking straws, said screw in said straw dispenser urging said bottommost straw outwardly from said straw dispenser when said straw dispenser is turned on thereby facilitating said bottommost straw to fall downwardly out of said straw dispenser wherein said stray dispenser is configured to deliver said bottommost straw to the user.

2. The assembly according to claim 1, wherein:
said lid housing has a top end, a bottom end and an outer wall extending between said top end and said bottom end, each of said top end and said bottom end being open to access an interior of said lid housing, said stack of drink container lids being oriented to extend between said top end and said bottom end, said outer wall being mounted to a vertical support surface such that top end and said bottom end are aligned with a common vertical axis;
said cover has a bottom side and a perimeter surface, said bottom side resting on said top end of said lid housing having said perimeter surface being aligned with said outer wall of said lid housing thereby closing said top end.

3. The assembly according to claim 2, wherein said lid dispenser unit comprises:
a lid control circuit being integrated into said lid housing, said lid control circuit receiving a dispense input;
a lid motion sensor being coupled to an inside surface of said outer wall of said lid housing, said lid motion sensor being positioned adjacent to said bottom end of said lid housing, said lid motion sensor sensing motion such that said lid motion sensor senses when the user's hand is positioned beneath said lid housing, said lid motion sensor being electrically coupled to said lid control circuit, said lid control circuit receiving said dispense input when said lid motion sensor senses motion; and
a lid motor being coupled to said inside surface of said outer wall of said lid housing, said lid motor being electrically coupled to said lid control circuit, said lid motor rotating a predetermined number of revolutions in a first direction when said lid motor is turned on, said lid motor being turned on when said lid control circuit receives said dispense input, said lid motor having an output shaft extending laterally away from said lid motor, said lid motor being positioned closer to said top end of said lid housing than said bottom end of said lid housing.

4. The assembly according to claim 3, wherein said lid dispenser includes:
a first gear having an engaging face and a coupling face, said coupling face being attached to said output shaft such that said lid motor rotates said first gear when said lid motor is turned on, said engaging face angling inwardly toward a centerline of said first gear;
a lid drive shaft having an upper end and a lower end, said lid drive shaft being positioned within said lid housing, said lid drive shaft being positioned between said outer wall of said lid housing and said stack of drink container lids; and
a second gear having an engaging face and a coupling face, said coupling face of said second gear being coupled to said upper end of said lid drive shaft, said engaging face of said second gear angling inwardly toward a centerline of said second gear, said engaging face of said second gear engaging said engaging face of said first gear such that each of said first gear and said second gear transfer rotational torque at a perpendicular angle, said lid drive shaft being rotated when said output shaft rotates.

5. The assembly according to claim 4, wherein said lid screw is coupled to said lower end of said lid drive shaft such that said lid screw rotates about an axis extending between said upper end and said lower end of said lid drive shaft when said lid drive shaft is rotated, a thread of said lid screw engaging said bottommost lid on said stack of drink container lids, said thread urging said bottommost lid downwardly when said lid screw rotates, said lid screw being rotated one full rotation when said lid motor is turned on thereby facilitating said lid screw to fully dislodge said bottommost lid from said stack of drink container lids.

6. The assembly according to claim 2, wherein:
said hand sanitizer dispenser is positioned on an outside surface of said outer wall of said lid housing, said hand sanitizer dispenser being positioned adjacent to said top end of said outer wall of said lid housing; and
said hand sanitizer includes a pump and a motion sensor, said pump being directed downwardly on said hand sanitizer, said motion sensor being electrically coupled to said pump, said pump being turned on when said motion sensor senses motion, said pump urging said pre-determined volume of said liquid hand sanitizer outwardly from said hand sanitizer dispenser when said pump is turned on.

7. The assembly according to claim 2, wherein said straw dispenser comprises:
a straw housing being attached to said outer surface of said outer wall of said lid housing, said straw housing having a lower end being open;
a straw control circuit being integrated into said lid housing, said straw control circuit receiving a dispense input;
a straw motion sensor being coupled to an inside surface of said outer wall of said lid housing, said straw motion sensor being positioned adjacent to said bottom end of said lid housing, said straw motion sensor sensing motion such that said straw motion sensor senses when the user's hand is positioned beneath said lid housing, said straw motion sensor being electrically coupled to said straw control circuit, said straw control circuit receiving said dispense input when said straw motion sensor senses motion; and
a straw motor being coupled to said inside surface of said outer wall of said lid housing, said straw motor being electrically coupled to said straw control circuit, said straw motor rotating a predetermined number of revolutions in a first direction when said straw motor is turned on, said straw motor being turned on when said straw control circuit receives said dispense input, said straw motor having an output shaft extending laterally away from said straw motor, said straw motor being positioned closer to said top end of said lid housing than said bottom end of said lid housing.

8. The assembly according to claim 7, wherein said straw dispenser includes:
a primary gear having an engaging face and a coupling face, said coupling face of said primary gear being attached to said output shaft of said straw motor such that said straw motor rotates said primary gear when said straw motor is turned on, said engaging face of said primary gear angling inwardly toward a centerline of said primary gear;
a straw drive shaft having an upper end and a lower end, said straw drive shaft being positioned within said straw housing, said straw drive shaft being positioned between said outer wall of said lid housing and said stack of drinking straws;
a secondary gear having an engaging face and a coupling face, said coupling face of said secondary gear being coupled to said upper end of said straw drive shaft, said engaging face of said secondary gear angling inwardly toward a centerline of said secondary gear, said engaging face of said secondary gear engaging said engaging face of said primary gear such that each of said primary gear and said secondary gear transfer rotational torque at a perpendicular angle, said straw drive shaft being rotated when said output shaft of said straw motor rotates.

9. The assembly according to claim 8, wherein said straw screw is coupled to said lower end of said straw drive shaft such that said straw screw rotates about an axis extending between said upper end and said lower end of said straw drive shaft when said straw drive shaft is rotated, a thread of said straw screw engaging said bottommost straw on said stack of drinking straws, said thread on said straw screw urging said bottommost straw downwardly when said straw screw rotates, said straw screw being rotated one full rotation when said straw motor is turned on thereby facilitating said straw screw to fully dislodge said bottommost straw from said stack of drinking straws.

10. The assembly according to claim 1, further comprising:
a lid control circuit;
a straw control circuit;
a pump integrated into said hand sanitizer dispenser; and
a power supply being coupled to said lid housing, said power supply being electrically coupled to said lid control circuit and said straw control circuit and said pump in said hand sanitizer dispenser, said power supply including a power cord extending away from an outer wall of said lid housing, said power cord having a distal end with respect to said outer wall, said power cord having a male plug being electrically coupled to said distal end, said male plug engaging a power source comprising a female electrical outlet.

11. A drink lid dispenser assembly for dispensing a lid for a drink container in a touchless manner thereby inhibiting contact transmission of bacteria, said assembly comprising:
a lid housing containing a stack of drink container lids, said lid housing having a top end, a bottom end and an outer wall extending between said top end and said bottom end, each of said top end and said bottom end being open to access an interior of said lid housing, said stack of drink container lids being oriented to extend between said top end and said bottom end, said outer wall being mounted to a vertical support surface such that top end and said bottom end are aligned with a common vertical axis;
a cover being removably positioned on said lid housing for closing said lid housing, said cover having a bottom side and a perimeter surface, said bottom side resting on said top end of said lid housing having said perimeter surface being aligned with said outer wall of said lid housing thereby closing said top end;
a lid dispenser unit being movably integrated into said lid housing, said lid dispenser unit including a lid screw engaging a bottommost lid in said stack of drink container lids, said lid screw separating said bottommost lid when said lid dispenser is turned on thereby facilitating said bottommost lid to fall outwardly from said lid housing wherein said lid dispenser unit is configured to deliver said bottommost lid to a user, said lid dispenser unit comprising:
a lid control circuit being integrated into said lid housing, said lid control circuit receiving a dispense input;
a lid motion sensor being coupled to an inside surface of said outer wall of said lid housing, said lid motion sensor being positioned adjacent to said bottom end of said lid housing, said lid motion sensor sensing motion such that said lid motion sensor senses when the user's hand is positioned beneath said lid housing, said lid motion sensor being electrically coupled to said lid control circuit, said lid control circuit receiving said dispense input when said lid motion sensor senses motion;
a lid motor being coupled to said inside surface of said outer wall of said lid housing, said lid motor being electrically coupled to said lid control circuit, said lid motor rotating a predetermined number of revolutions in a first direction when said lid motor is turned on, said lid motor being turned on when said lid control circuit receives said dispense input, said lid motor having an output shaft extending laterally away from said lid motor, said lid motor being positioned closer to said top end of said lid housing than said bottom end of said lid housing;
a first gear having an engaging face and a coupling face, said coupling face being attached to said output shaft such that said lid motor rotates said first gear when said lid motor is turned on, said engaging face angling inwardly toward a centerline of said first gear;
a lid drive shaft having an upper end and a lower end, said lid drive shaft being positioned within said lid housing, said lid drive shaft being positioned between said outer wall of said lid housing and said stack of drink container lids;
a second gear having an engaging face and a coupling face, said coupling face of said second gear being coupled to said upper end of said lid drive shaft, said engaging face of said second gear angling inwardly toward a centerline of said second gear, said engaging face of said second gear engaging said engaging face of said first gear such that each of said first gear and said second gear transfer rotational torque at a perpendicular angle, said lid drive shaft being rotated when said output shaft rotates; and
wherein said lid screw is coupled to said lower end of said lid drive shaft such that said lid screw rotates about an axis extending between said upper end and said lower end of said lid drive shaft when said lid drive shaft is rotated, a thread of said lid screw engaging said bottommost lid on said stack of drink container lids, said thread urging said bottommost lid downwardly when said lid screw rotates, said lid screw being rotated one full rotation when said lid motor is turned on thereby facilitating said lid screw to fully dislodge said bottommost lid from said stack of drink container lids;
a hand sanitizer dispenser being attached to said lid housing, said hand sanitizer dispenser containing a liquid hand sanitizer, said hand sanitizer dispenser having a dispensing element for releasing a pre-determined volume of said liquid hand sanitizer when the user positions their hand beneath said hand sanitizer dispenser, said hand sanitizer dispenser being positioned on an outside surface of said outer wall of said lid housing, said hand sanitizer dispenser being positioned adjacent to said top end of said outer wall of said lid housing, said hand sanitizer having a pump and a motion sensor, said pump being directed downwardly on said hand sanitizer, said motion sensor being electrically coupled to said pump, said pump being turned on when said motion sensor senses motion, said pump urging said pre-determined volume of said liquid hand sanitizer outwardly from said hand sanitizer dispenser when said pump is turned on; and
a straw dispenser being coupled to said lid housing, said straw dispenser containing a stack of drinking straws, said straw dispenser including a screw engaging a bottommost straw in said stack of drinking straws, said screw in said straw dispenser urging said bottommost straw outwardly from said straw dispenser when said straw dispenser is turned on thereby facilitating said bottommost straw to fall downwardly out of said straw dispenser wherein said stray dispenser is configured to deliver said bottommost straw to the user, said straw dispenser comprising:
a straw housing being attached to said outer surface of said outer wall of said lid housing, said straw housing having a lower end being open;
a straw control circuit being integrated into said lid housing, said straw control circuit receiving a dispense input;
a straw motion sensor being coupled to an inside surface of said outer wall of said lid housing, said straw motion sensor being positioned adjacent to said bottom end of said lid housing, said straw motion sensor sensing motion such that said straw motion sensor senses when the user's hand is positioned beneath said lid housing, said straw motion sensor being electrically coupled to said straw control circuit, said straw control circuit receiving said dispense input when said straw motion sensor senses motion;
a straw motor being coupled to said inside surface of said outer wall of said lid housing, said straw motor being electrically coupled to said straw control circuit, said straw motor rotating a predetermined number of revolutions in a first direction when said straw motor is turned on, said straw motor being turned on when said straw control circuit receives said dispense input, said straw motor having an output shaft extending laterally away from said straw motor, said straw motor being positioned closer to said top end of said lid housing than said bottom end of said lid housing;
a primary gear having an engaging face and a coupling face, said coupling face of said primary gear being attached to said output shaft of said straw motor such that said straw motor rotates said primary gear when said straw motor is turned on, said engaging face of said primary gear angling inwardly toward a centerline of said primary gear;
a straw drive shaft having an upper end and a lower end, said straw drive shaft being positioned within said straw housing, said straw drive shaft being positioned between said outer wall of said lid housing and said stack of drinking straws;
a secondary gear having an engaging face and a coupling face, said coupling face of said secondary gear being coupled to said upper end of said straw drive shaft, said engaging face of said secondary gear angling inwardly toward a centerline of said secondary gear, said engaging face of said secondary gear engaging said engaging face of said primary gear such that each of said primary gear and said secondary gear transfer rotational torque at a perpendicular angle, said straw drive shaft being rotated when said output shaft of said straw motor rotates; and
wherein said straw screw is coupled to said lower end of said straw drive shaft such that said straw screw rotates about an axis extending between said upper end and said lower end of said straw drive shaft when said straw drive shaft is rotated, a thread of said straw screw engaging said bottommost straw on said stack of drinking straws, said thread on said straw screw urging said bottommost straw downwardly when said straw screw rotates, said straw screw being rotated one full rotation when said straw motor is turned on thereby facilitating said straw screw to fully dislodge said bottommost straw from said stack of drinking straws; and
a power supply being coupled to said lid housing, said power supply being electrically coupled to said lid control circuit and said straw control circuit and said pump in said hand sanitizer dispenser, said power supply including a power cord extending away from said outer wall of said lid housing, said power cord having a distal end with respect to said outer wall, said power cord having a male plug being electrically coupled to said distal end, said male plug engaging a power source comprising a female electrical outlet.
